(19) United States
(12) Patent Application Publication
(10) Pub. No.: US 2026/0023618 A1
(43) Pub. Date: Jan. 22, 2026

(54) SCALABLE CLOUD EXECUTION OF MACHINE LEARNING TASKS

(71) Applicant: NVIDIA Corporation, Santa Clara, CA (US)

(72) Inventors: Steve Masson, Fremont, CA (US); Ramanathan Arunachalam, Austin, TX (US); Arun George Zachariah, San Jose, CA (US); Varun Praveen, Cupertino, CA (US)

(21) Appl. No.: 18/774,660

(22) Filed: Jul. 16, 2024

(51) Int. Cl. G06F 9/50

(52) U.S. Cl. CPC G06F 9/505; G06F 9/5038; G06F 2209/5022

(57) ABSTRACT

Disclosed are devices, systems, and techniques for provisioning of scalable machine learning operations on a cloud-based server. The techniques include receiving from a client device, via a cloud service API, authorization data and receiving from the client device, via the cloud service API, a selection of a task to be executed in association with a machine learning model. The techniques further include allocating, from a shared pool of cloud computing resources, one or more processors to execute the task, wherein the shared pool of cloud computing resources is being concurrently used for execution of a plurality of additional tasks received from one or more additional client devices. The techniques further include instantiating an execution container comprising one or more compute backends, receiving, using the authorization data, the user data into the execution container, and executing, using the one or more processors, the task in the execution container.

### TECHNICAL FIELD

At least one embodiment pertains to processing resources used to perform and facilitate artificial intelligence. For example, at least one embodiment pertains to efficient training, adapting, optimizing, and deploying machine learning models using cloud-based platforms.

### BACKGROUND

Machine learning (ML) is often used in office, industrial, and hospital environments, medical imaging, robotic automation, security applications, autonomous transportation, law enforcement, and many other settings. In particular, machine learning has applications in audio, image, and video processing, such as in voice, speech, and object recognition. One popular approach to machine learning involves training a computing system using training data (sounds, images, actions, facial expressions, texts, and/or other data) to identify patterns in the data that may facilitate data classification, such as the presence of a particular type of an object within a training image or a particular word within a training speech or text. Training can be supervised or unsupervised. Machine learning models can use various computational algorithms, such as decision tree algorithms (or other rule-based algorithms), artificial neural networks, and the like. After a deployment of a trained machine learning model-during inference stage-new data is input into the trained machine learning model and various target objects, sounds, sentences, actions, an/or any other target patterns can be identified using patterns and features established during training.

### BRIEF DESCRIPTION OF DRAWINGS

FIG. 1A is a block diagram of an example cloud architecture that supports scalable cloud execution of machine learning (ML) tasks, according to at least one embodiment;

FIG. 1B illustrates an example computing device capable of supporting scalable cloud execution of ML tasks, according to at least one embodiment, according to at least one embodiment;

FIG. 2 illustrates schematically scalable ML operations of a cloud-based server, according to at least one embodiment;

FIG. 3 illustrates schematically an example container-based execution of scalable ML operations on a cloud-based server, according to at least one embodiment;

FIG. 4 illustrates schematically example modes of interaction between a user of a client device and a cloud server supporting ML operations, according to at least one embodiment;

FIG. 5 illustrates schematically a flow of events during scalable cloud execution of ML tasks, according to at least one embodiment;

FIG. 6 is a flow diagram of an example method of performing scalable ML operations using a cloud-based server, in accordance with at least some embodiments;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment; and

FIG. 11 illustrates an example data center system, according to at least one embodiment.

### DETAILED DESCRIPTION

Machine learning has become a staple in a multitude of industries and technological fields where at least some levels of decision-making can be delegated to computer systems. Historically, development of machine learning models (MLMs) has been a province of sophisticated software developers and data scientists with expertise in efficient utilization of hardware resources available for MLM embodiment. A developer had to select a type of an MLM (e.g., a neural network) and a specific architecture (e.g., a number and type of neural layers, connections, activation functions, classifiers, etc.) suitable for a specific target domain (e.g., speech, computer vision, etc.) and an application (e.g., speech recognition or synthesis). Eventually, developer packages (e.g., software development kits or SDKs) appeared that abstracted away some of the developmental tasks and enabled users with less sophisticated backgrounds to set up, train, and deploy MLMs. Such packages can effectively utilize local processing and memory resources available on a user's computer. Some SDK packages extend to cloud-based MLM operations. A user of cloud-based MLM services typically subscribes to a certain cluster of computing resources that include a number of graphics processing units (GPUs), central processing units (CPUs), memory devices, and/or the like. The user then executes one or more MLM tasks (such as MLM training, fine-tuning, inference with trained MLM(s), etc.) using the cloud-provided compute backends and the subscribed hardware cluster. However, at those times where the number and/or complexity of the MLM tasks overwhelms the subscribed cluster resources, the user-executed tasks can experience significant latency. At other times, the user can run a lighter load of MLM tasks so that at least a portion of the subscribed cluster remains idle or underutilized. Accordingly, in many (if not most) instances, the user's service can be suboptimal from an efficiency perspective as, alternatively, undersubscribed or oversubscribed.

Aspects and embodiments of the present disclosure address these and other challenges of the modern MLM technology by providing for methods and systems that enable efficient and flexible MLM operations free from fixed-sized cluster constraints. In some embodiments, an application programming interface (API) that facilitates cloud-based development and deployment of MLMs may be provided to a client computer via a remote-access client (e.g., a browser-supported client, etc.). The API may authenticate a remote user and receive one or more requests (control commands) from the user, e.g., requests to train one or more MLMs using user's data, fine-tune one or more pretrained MLMs, evaluate one or more trained MLMs using new data, optimize (e.g., prune and/or quantize) one or more trained/tuned MLMs for deployment on user-specified hardware, process inference data, and/or perform any other suitable MLM-related tasks. The API may include (or communicate with) a workflow engine (WFE) of the cloud service. The WFE may convert control commands received from the user into low-level codes and routines that may be executed using various compute backends, e.g., TensorFlow®, PyTorch®, TensorRT®, ONNX®, Keras®, and the like. The WFE may evaluate the scope and number of computational operations (e.g., GPU/CPU clock cycles, memory reads/writes, and/or the like) required to execute the user's tasks and allocate a corresponding number and type of hardware resources of the cloud compute platform for execution of the user's requests. In some embodiments, the cloud compute resources allocated to the user may be a small fraction of the total cloud-based resources simultaneously shared by many (e.g., tens, hundreds, or more) users. As a result, the user is seamlessly allocated as many resources as may be needed to execute the user's tasks or, in some instances, specific resources explicitly requested by the user (e.g., four NVIDIA® A100 GPUS).

The WFE may maintain a priority queue of requests, schedule and supervise jobs for execution on the compute backends and may orchestrate execution of the user's tasks on the allocated compute platform resources. In some embodiments, the user's tasks may be executed using insulate containers (e.g., Kubernetes containers, DOCKER containers, and/or the like) by grouping user's actions into logical units and running such units in separate containers, e.g., with different containers instantiated for different MLMs or for different actions related to the same MLM, such as fine-tuning, optimization, deployment, and/or the like. In some embodiments, a container may include a data controller that loads any suitable data from user's cloud space (which may be different from the compute cloud service), including but not limited to user training datasets, hyperparameters for the MLMs, such as a learning rate, a size of a batch of training data, a number of training epochs, and/or the like. For example, the data controller may receive web address(es) of the user's cloud space together with authentication/credentials information (e.g., passwords, password hashes, etc.) through one or more requests communicated from the user via the cloud API. During execution of a user's task, the data controller may regularly communicate status updates to the user about the actions being executed and may further store intermediate data (e.g., training results, logs, checkpoints, and/or the like) on the user's cloud space. The data controller may similarly download parameters (e.g., weights and biases) of pretrained MLM(s) prior to the container execution and then periodically store updated intermediate parameters of the MLMs being trained, e.g., after completion of a certain number of training epochs.

In one embodiment, scalable hardware-agnostic cloud-based MLM operations can be performed as follows. A client portion of the API (“client API”) installed on a user's computer (client device) may receive one or more user's requests for MLM tasks to be performed by the cloud service. The client API may forward the requests to the cloud portion of the API (“cloud API”) that may receive the requests at its endpoint managing a queue of such requests, e.g., to annotate data, train an MLM, fine-tune a pretrained MLM, export/deploy an MLM, perform inference using a trained MLM, and/or the like. The cloud API may then cause the WFE to create a task container associated with the request. The WFE may identify hardware resources (or virtual processing resources, in one embodiment) to be used for execution of the task container. The controller of a compute platform (e.g., NVIDIA® Cloud Functions or NVCF) may then allocate the identified resources and instantiate the container. The container may initiate target tasks, e.g., MLM training/evaluation/deployment/etc., training data annotation or augmentation, and/or the like, and may download various associated data (e.g., training dataset, pretrained MLMs, etc.) from a suitable user-specified cloud storage. The user-requested tasks (actions) may then be executed within the container using one or more compute backends that are specified by the user or—if no user preference is received—by the WFE based on the type of MLM, amount and/or format of the training data, and/or the like. During container execution, various intermediate and final results of the task execution may be periodically reported to the user via the client API and various intermediate data may be stored on the user's cloud storage and/or workspace. After completion of the task execution, reporting and storing the final results, the cloud computing resources may be deallocated and returned to the common pool of resources. The container may then be deleted to ensure security of sensitive user data.

The advantages of the disclosed techniques include, but are not limited to, flexible and efficient execution of MLM-related tasks on a large pool of shared computing resources, which are allocated on-demand and de-allocated when computational tasks are completed. This significantly reduces per-task costs of the MLM task processing while eliminating idle time of fixed-hardware clusters.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be implemented in a variety of different systems such as automotive systems (e.g., a control system for an autonomous or semi-autonomous machine, a perception system for an autonomous or semi-autonomous machine, an in-vehicle infotainment system for an autonomous or semi-autonomous machine, etc.), systems implemented using a robot, aerial systems, medical systems, boating systems, smart area monitoring systems, systems for performing deep learning operations, systems for performing simulation operations, systems for performing digital twin operations, systems for performing medical operations, systems for performing factory operations, systems for performing analytics operations, systems for performing medical operations, systems for performing factory operations, systems for performing analytics operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) or vision language models (VLMs) that may process text, voice, image, and/or other data types to generate outputs in one or more formats, systems implemented at least partially using cloud computing resources, systems for performing generative AI operations, and/or other types of systems.

### System Architecture

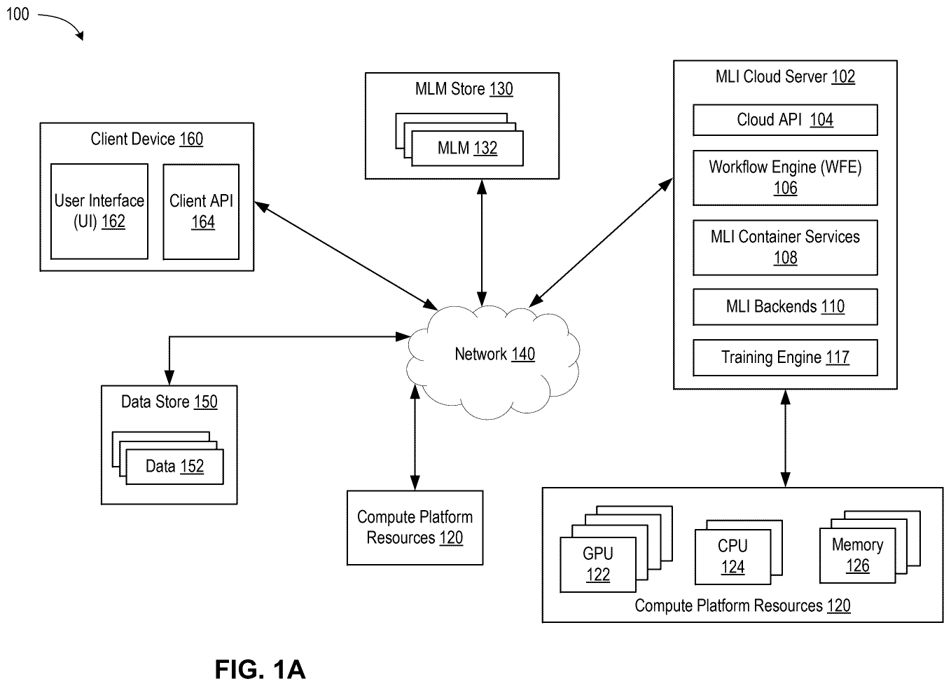

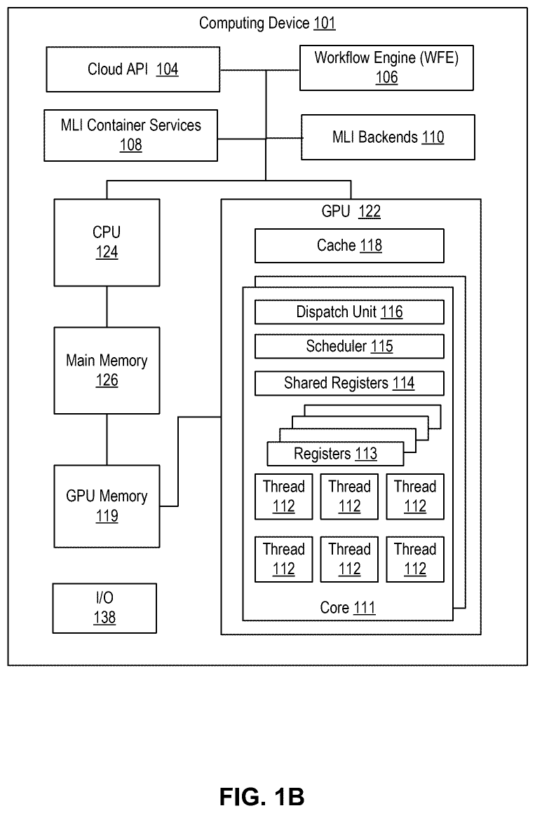

FIG. 1A is a block diagram of an example cloud architecture 100 that supports scalable cloud execution of machine learning tasks, according to at least one embodiment. As depicted in FIG. 1A, example architecture 100 may be implemented on multiple computing devices, including ML infrastructure (MLI) cloud server 102 and client device 160, etc., and may further use multiple data repositories, including but not limited to an MLM store 130 and data store 150. In some embodiments, any of the modules and/or components of cloud architecture 100 may be implemented using more or fewer devices than shown in FIG. 1A. In some embodiments, any of the modules and components of cloud architecture 100 may be implemented on a single computing device, e.g., MLI cloud server 102.

MLI cloud server 102 may be or include one or more desktop computers, server computers, rackmount servers, data centers, compute centers, servers that utilize a virtualized computing environment, and/or any combination thereof. A user may have local or remote (e.g., over a network) access to MLI cloud server 102. For example, the user may access MLI cloud server 102 via a client device 160, which may include one or more desktop computers, laptop computers, tablet computers, server, computing devices that access a remote server, a gaming console, a wearable computer, a mixed/virtual/augmented reality headset, a smart TV, or any other type of computing devices, or any combination of multiple computing devices. MLI cloud server 102 may use any number of compute platform resources 120, which may include any number of distributed computing nodes communicating via a suitable bus, interconnect, or network (e.g., network 140), and/or the like. Compute platform resources 120 may include any number of graphics processing units (GPUs) 122, central processing units (CPUs) 124, parallel processing units (PPUs), data processing units (DPUs), accelerators, field-programmable gate arrays (FPGAs), application-specific integrated circuits (ASICs), and/or other suitable processing devices capable of performing the techniques described herein. GPUs 122 and/or CPUs 124 may support any number of virtual CPUs and/or virtual GPUs. Compute platform resources 120 may further include one or more memory devices, also referred to simply as memory 126 herein. MLI cloud server 102 may further have access (e.g., over network 140) to any number of peripheral devices and/or edge devices (not shown in FIG. 1A), including but not limited to cameras (e.g., video cameras) for capturing images (or sequences of images, e.g., videos), microphones for capturing sounds, scanners, physical or chemical sensors, or any other devices for intake of data 152. In some embodiments, data 152 may be stored in data store 150. A user of a client device 160 may have access to at least some of data 152 in data store 150. In some embodiments, access to data 152 may be granted based on access levels, e.g., defined at individual user level, group level, organization level, and/or the like.

In some embodiments, MLI cloud server 102 may include any number of engines and components that facilitate scalable ML operations, including but not limited to training, adapting, evaluating, optimizing, and deploying MLMs. A user (e.g., customer, end user, developer, data scientist, etc.) may interact with MLI cloud server 102 via a (remote-access) user interface (UI) 162, which may include a command line, a graphics-based UI, a web-based UI (e.g., a web browser-supported interface), a mobile application-based UI, or any combination thereof. UI 162 may display menus, tables, graphs, flowcharts, graphical and/or textual representations of software, dataflows, and workflows. UI 162 may include selectable items, which may allow the user to identify MLMs to be trained, optimized, and/or deployed, select hyperparameters for MLM training, location of training and inference, and/or the like. User actions, parameters, and settings entered via UI 162 may be communicated to MLI cloud server 102 via client API 164 installed on client device 160. In some embodiments, UI 162 and/or client API 164 may be downloaded to client device 160 from MLI cloud server 102 or any other computing or memory device associated with the cloud-based MLI service. The downloaded API package may be used to install client API 164 and/or UI 162 to allow the user to have two-way communication with a cloud API 104 instantiated on MLI cloud server 102.

Client API 164 may provide to the user a set of control commands that can be understood by MLI cloud server 102 as instructions that request training, adapting, optimizing, and or deploying one or more MLMs 132, and/or instructions that request processing of inference data, which may include data 152 stored in data store 150 and/or data generated at runtime by any sensors, such as imaging sensors, video sensors, audio sensors, physical sensors, chemical sensors, and/or any other suitable sensors, and/or any combination thereof. The control commands, made available to user via client API 164, may include commands that cause MLI cloud server 102 to train one or more MLMs, augment or annotate data used in training of the MLM(s), prune (reduce complexity) of trained MLM(s), evaluate trained MLM(s), export trained MLM(s), perform inference of data using trained MLM(s), and/or the like.

MLI cloud server 102 may deploy a number of modules and components configured to process and implement one or more control commands issued by a user and received via client API 164 and cloud API 104. Execution of commands and requests received from the user via client API 164/cloud API 104 may be facilitated and managed by a workflow engine (WFE) 106. WFE 106 may convert control commands received from the user into low-level codes and routines that may be executed using various available ML infrastructure (MLI) backends (frameworks) 110, e.g., TensorFlow®, PyTorch®, TensorRT®, ONNX®, Keras®, and/or the like. WFE 106 may schedule and supervise jobs for execution on the MLI backends 110. WFE 106 may include a dependency checker component to determine and enforce data and resource prerequisites for execution of jobs, identify and obtain missing dependencies, metadata, and/or the like. WFE 106 may scan for pending and completed jobs and maintain a priority queue of pending and future jobs, including handling queues of multiple users and/or user groups.

MLI backends 110 should be understood as any software resources, packages, toolkits, software development kits (SDKs) that can execute on any suitable hardware, including but not limited to one or more GPUs 122, one or more CPUs 124, and any other processing resources. Individual MLI backends 110 may include executable codes, libraries, and configuration files. MLI backends 110 may be used to perform training of MLMs 132, optimization of MLMs 132, evaluation (validation) of MLMs 132, inference processing using MLMs 132, and/or perform other suitable processing operations. In some embodiments, at least some of the functionality of MLI cloud server 102 may be supported by (e.g., split between) multiple computing devices. For example, some of MLI backends 110 may be located on one or more separate computing devices connected to MLI cloud server 102 over network 140 or a bus/interconnect.

MLI cloud server 102 may include MLI container services 108 for secure insular execution of various user-requested MLM tasks, e.g., using Kubernetes containers, DOCKER containers, and/or the like. In some embodiments, MLI cloud server 102 may include a training engine 117 capable of efficient training of one or more MLMs 132. In particular, training engine 117 may initiate a series of experiments to determine training hyperparameters for optimal training of MLM(s) 132, evaluate success of different experiments, and complete training of MLM(s) using a specific set of training hyperparameters, e.g., a set that maximizes MLM(s) performance, minimizes MLM(s) training time, and/or satisfies other suitable target criteria.

MLMs 132 may be pre-trained and stored in MLM store 130 accessible to MLI cloud server 102 over a network 140. Network 140 may be a public network (e.g., the Internet), a private network (e.g., a local area network (LAN), or wide area network (WAN)), a wireless network, a personal area network (PAN), or a combination thereof. MLMs 132 may include regression algorithms, decision trees, support vector machines, K-means clustering models, neural networks, or any other machine learning algorithms. Neural network MLMs may include convolutional, recurrent, fully-connected, Long Short-Term Memory (LSTM) models, models with attention, transformer models, encoder-decoder models, encoder-only models, decoder-only models, Hopfield, Boltzmann, or any other types of neural networks. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating MLMs 132 may include setting (e.g., randomly) initial parameters (weights, biases) of various nodes of the networks. The generated MLMs 132 may be trained by using training data that may include training input(s) and corresponding target output(s). During training of MLMs 132, a training software (e.g., executed by one of MLI backends 110) may identify patterns in training input(s) based on desired target output(s) and train the respective MLMs 132 to perform desired tasks. Predictive utility of the identified patterns may subsequently be verified using additional training input/target output associations before being used for processing of new data during the inference stage.

FIG. 1B illustrates an example computing device 101 capable of supporting scalable cloud execution of ML tasks, according to at least one embodiment. In at least one embodiment, computing device 101 may support any, some or all of cloud API 104, workflow engine 106, training engine 117, MLI container services 108, MLI backends 110, and/or other programs and applications may be executed using one or more GPUs 122 (and/or other parallel processing units (PPUs) or accelerators, such as a deep learning accelerator, a data processing unit (DPU), etc.) and one or more CPUs 124. In at least one embodiment, a GPU 122 includes multiple cores 111, some or all cores being capable of executing multiple threads 112. Some or all cores may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, some or all cores 111 may include a scheduler 115 to distribute computational tasks and processes among different threads 112 of respective core 111. A dispatch unit 116 may implement scheduled tasks on appropriate threads using correct private registers 113 and shared registers 114. MLI cloud server 102 may include input/output component(s) 138 to facilitate exchange of information with one or more users or developers.

In at least one embodiment, GPU 122 may have a (high-speed) cache 118, access to which may be shared by multiple cores 111. Furthermore, MLI cloud server 102 may include a GPU memory 119 where GPU 122 may store intermediate and/or final results (outputs) of various computations performed by GPU 122. After completion of a particular task, GPU 122 (or CPU 124) may move the output to (main) memory 126. In at least one embodiment, CPU 124 may execute processes that involve serial computational tasks whereas GPU 122 may execute tasks (such as multiplication of inputs of a neural node by weights and adding biases) that are amenable to parallel processing. In at least one embodiment, WFE 106 may determine which processes are to be executed on GPU 122 and which processes are to be executed on CPU 124.

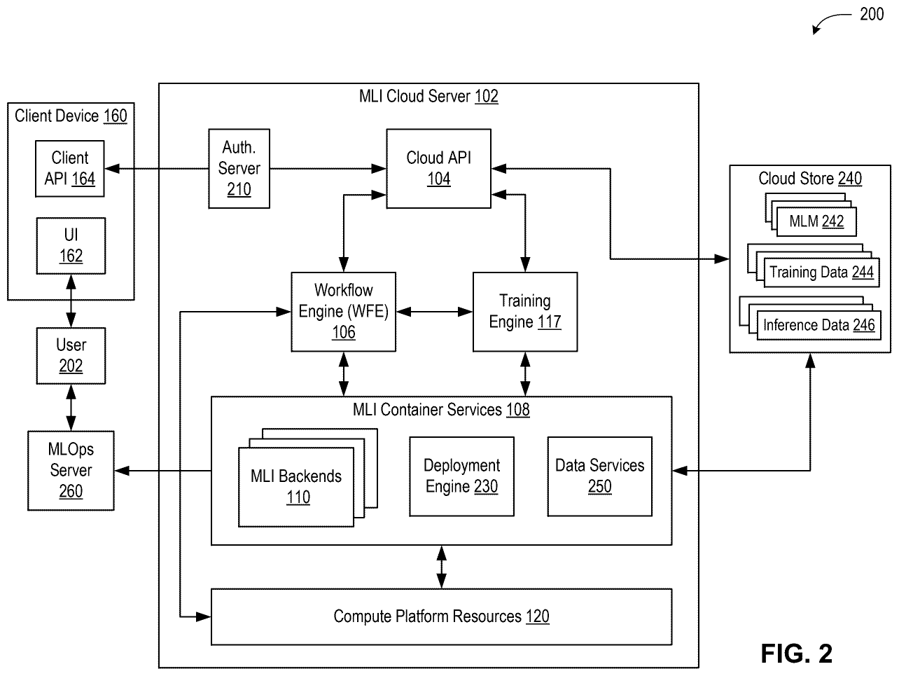

FIG. 2 illustrates schematically scalable ML operations 200 of a cloud-based server, according to at least one embodiment. The cloud-based server may be or include MLI cloud server 102. Scalable ML operations 200 may include receiving one or more user inputs from a user 202 via client API 164, e.g., via UI 162, which may include a command line interface, a browser-based interface, a proprietary graphics interface, and/or any combination thereof. Client API 164 may be a client device counterpart of cloud API 104 operating on MLI cloud server 102. Access by user 202 to cloud API 104 may be controlled by authentication server 210. Authentication server 210 may enforce various access categories and/or user groups, e.g., at organizational level, group level, user level, and/or the like. For example, an administrator of MLI cloud server 102 may identify access rights for a specific organization (e.g., company, government office, etc.), which may include an amount of processing and memory resources allocated for use by the organization, such as a number of GPUs/CPUs, virtual GPUs/CPUs, units of memory, network bandwidth, and/or the like. Individual organizations may further establish group (team) rights and individual group rights for various members of the organizations. For example, a specific user may be granted up to two GPU during peak hours and up to four GPUs during off-peak hours. In some embodiments, user 202 may have unlimited (elastic) access to computational resources of MLI cloud server 210 that is scaled up (and down) as necessary depending on the number and complexity of tasks executed by user 202. Authentication server 210 may enforce access rights of various users, teams, organizations, and the like, using passwords, cryptographic encryption, digital authentication, and/or other suitable techniques of data protection. For example, while pre-trained models may be accessible to multiple users/groups of users, models that are trained on user's data may protected by authentication server 210 from unauthorized accesses by other users/groups. Similarly protected may be various user's data, including training data, training hyperparameters, training/optimizing/deployment logs, data generated by deployed models, and/or the like.

Inputs from user 202 may be delivered to MLI cloud server 102 via a number of API commands supported by cloud API 104/client API 164 including but not limited to TRAIN command, EVALUATE command, PRUNE command, QUANTIZE command, EXPORT command, AUGMENT command, INFER command, and/or any other suitable commands as may be defined by cloud API 104 and supported by WFE 106, and/or training engine 117. Inputs from user 202 may identify various user data, which may be stored in cloud store 240 on user's storage space or workspace. In some embodiments, cloud store 240 may be maintained by a provider different from a provider of MLI cloud server 102. In some embodiments, cloud store 240 may include at least some of MLM store 130 and/or data store 150 of FIG. 1A. User data stored on cloud store 240 may include one or more MLMs 242 (which may include one or more MLM(s) of FIG. 1A) at any stage(s) of training and/or optimization, e.g., pre-trained MLMs, fine-tuned MLMs, pruned/quantized MLMs, MLMs optimized for execution on a particular set of computing resources, and/or the like. Some of MLMs 242 may be MLMs trained (and/or pretrained) and provided by MLI cloud server 102. Cloud store 240 may further store training data 244 capable of being used for MLM training, evaluation, optimization, etc. tasks.

Cloud API 104 may eliminate the need to register MLM(s) 242 and/or data 244-246 with MLI cloud server 102 and may facilitate operations that are agnostic as to the specifics of cloud store 240. In particular, cloud store 240 may include any suitable user cloud storage, including public cloud storage, private cloud storage, hybrid cloud storage, community cloud storage, and/or the like. Cloud store 240 may include a file storage, a block storage, an object storage, and/or the like. User may communicate, via client API 164, one or more addresses (e.g., URL addresses) of where MLM(s) 242 and/or data 244-246 are stored and any suitable authentication credentials (e.g., usernames, passwords, password hashes, etc.), and the MLI cloud server 102 may automatically access and download the stored content from cloud store 240.

WFE 106 of a compute platform (e.g., NVIDIA® Cloud Functions or NVCF) may then allocate the identified resources and instantiate the container. The container may initiate target tasks, e.g., MLM training/evaluation/deployment/etc., training data annotation or augmentation, etc., and may download associated data (e.g., training dataset, pretrained MLMs, etc.) from a suitable user-specified cloud store (e.g., cloud store 240). The user-requested tasks (actions) may then be executed in the container using one or more MLI backends 110 that are specified by the user or—if no user preference is received—by the WFE 106 based on the type of MLM(s), amount and/or format of the training data, and/or the like.

WFE 106 may receive commands (requests) generated by client API 164 and may implement functionality requested by user 202 as a series of one or more jobs. A job can be any unit of computing work that WFE 106 identifies and schedules for execution of tasks on the compute platform resources 120 (e.g., a set of available GPU(s), CPU(s), memory devices, and/or the like, as described in conjunction with FIG. 1A). A job may be executed by processing devices subject to instructions of any suitable software program, including one or more MLI backends 110.

WFE 106 manages various jobs pertaining to operations related to tasks requested by various users 202 of MLI cloud server, such as training models, optimizing models, deploying of models, and/or the like. Different jobs may have different compute/memory requirements and may be scheduled for execution on different sets of compute platform resources 120. Some jobs may be executed on multiple GPUs and/or CPUs. Some jobs may be executed provided that certain prerequisites (job dependencies) are met, such as availability of certain datasets (e.g., training datasets), pre-trained models, and/or the like. WFE 106 may track dependencies of individual jobs and determine when various jobs have all prerequisites completed prior to scheduling jobs for execution.

Client API 164 may allow user 202 to send requests to WFE 106 to handle various jobs including requests to list, create, update, delete, execute jobs, retrieve status of jobs, upload and download data, and/or the like. WFE 106 may schedule jobs for execution using one or more MLI backends 110, e.g., TensorFlow®, PyTorch®, TensorRT®, ONNX®, Keras®, and/or other similar compute backends. Execution of jobs may be facilitated by one or more libraries (not shown in FIG. 2), e.g., loss function libraries to evaluate errors in training, learning rate schedulers to adjusts the learning rate between training epochs (iterations), pruning libraries to eliminate inefficient neurons as part of MLM optimization, augmentation libraries to generate variations in training data, annotation libraries to perform automated annotation of training data, various evaluation libraries to evaluate trained MLMs, and/or any other suitable libraries.

MLI cloud server 102 may further include training engine 117 for facilitating and performing various tasks associated with training of MLMs, including adaptive experiment-based training, which may include running multiple training experiments in parallel. More specifically, as part of training or fine-tuning of a particular MLM, training engine 117 may launch multiple experiments (or training tracks) using different sets of hyperparameters. Hyperparameters may include a learning rate, a regularization constant, parameters of gradient descent, a number of training epochs, a number of branches in a decision tree, a number of clusters in a clustering algorithm, and/or the like. In some embodiments, user 202 may specify target ranges for any, some, or all hyperparameters, e.g., minimum and maximum learning rates used in training of specific MLMs 242. In some embodiments, user 202 may further specify various evaluation metrics to be used to evaluate success of training. As training progresses, training engine 117 may evaluate multiple started tracks and discard underperforming tracks while maintaining one or more tracks whose evaluation gives higher scores given user-provided evaluation metrics or default evaluation metrics of the training engine 117 (if user 202 does not specify metrics). Training engine 117 may periodically provide progress reports, via client API 164 and UI 162, to user 202. In response to such reports, user 202 may review and change some of the hyperparameters used by training engine 117. In some instances, user 202 may stop and/or delete some of the tracks. User 202 may also create additional tracks (with specific hyperparameters) for training engine 117 to initiate and execute. Training engine 117 may also maintain logs (including real-time logs) associated with the training and then store such logs on cloud store 240 and/or display the logs on UI 162.

The WFE may estimate a number of computational operations required to execute jobs associated with user's tasks, such as a number of GPU and/or CPU clock cycles, memory reads/writes, etc., and allocate a corresponding number and type of compute platform resources 120 for efficient (e.g., latency-free or low latency) execution of the jobs. Since MLI cloud server 102 may be executing a large number of applications (e.g., per requests from multiple users), the cloud compute resources allocated to the tasks requested by user 202 may represent a small fraction, e.g., less than one tenth, less than one hundredth, and so on, of the total resources of MLI cloud server 102, user 202 may be allocated a sufficient amount of the resources to perform the user's tasks without affecting other tasks executed by MLI cloud server 102. In some instances, the amount of resources allocated by WFE 106 may be explicitly specified by user 202.

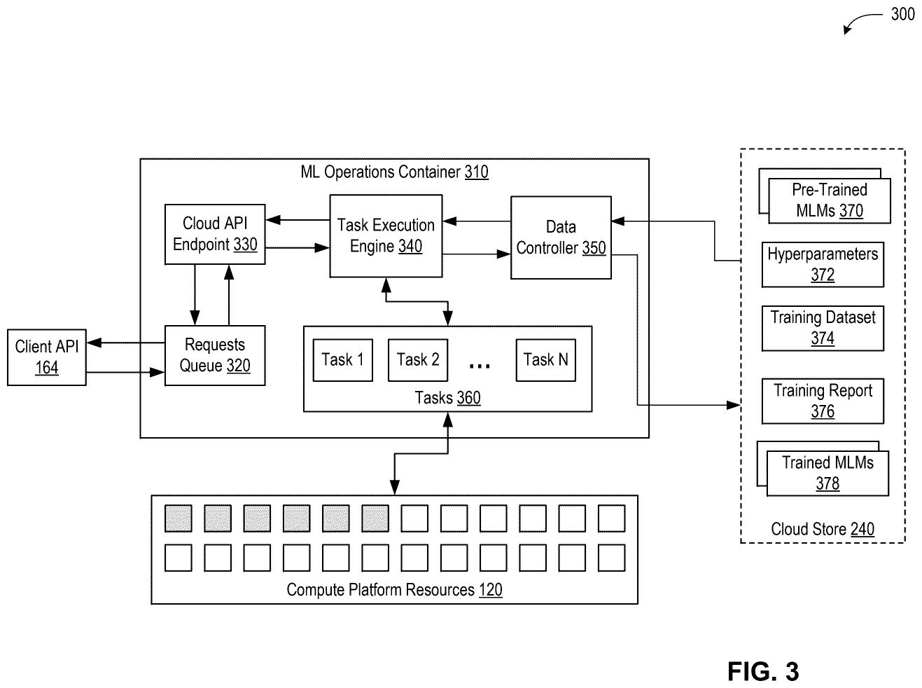

In some embodiments, to execute the user's tasks, WFE 106 may instantiate one or more containers supported by MLM container services 108. Execution of containers is illustrated in more detail in conjunction with FIG. 3 below. User's tasks may be assigned to one or more MLI backends 110, which may be capable of training, evaluating, optimizing, deploying for inference, etc., one or more MLMs 242. In some instances, the types of MLI backends (e.g., TensorFlow®, PyTorch®, TensorRT®, ONNX®, Keras®, and/or the like) may be selected by user 202. In other instances, WFE 106 may select MLI backend(s) 110 without a user input, e.g., if user 202 is inexperienced and/or has no preference. For example, the backend selection may be performed based on the type of MLM(s) 242 selected by user 202, the format of data (e.g., training data 244 and/or inference data 246) to be used with the MLM(s) 242, and/or the like. For example, WFE 106 may use one or more default MLI backends 110 for medical imaging models, speech recognition models, text recognition models, physical/chemical sensor models, and so on. In some embodiments, default MLI backends 110 may be set by an administrator of MLI cloud server 102. In some embodiments, default MLI frameworks may be set (or modified) by user 202.

Deployment engine 230 may format various jobs scheduled by WFE 106 for execution on trained MLMs, including optimizing models, pruning models, quantizing models, e.g., from a 32-bit floating-point (FP) format to a 16-bit, 8-bit, 4-bit FP format or to an integer number format. Deployment engine 230 may further configure one or more trained MLMs for execution on a computer system that is different from MLI cloud server 102, e.g., directly on client device 160 or some other system under control of user 202, which may be a system with fewer resources than MLI cloud server 102. Deployment engine 230 may also evaluate accuracy of deployment of the optimized models on such lower-resource computing systems, e.g., by running one or more sets of evaluation data through the models and comparing the accuracy of the outputs to the predictions of the models prior to optimization/reconfiguration.

Data services 250 may perform any suitable operations on training data 244 and/or inference data 246, including but not limited to pre-processing the data (e.g., de-noising data, reformatting data, filtering data, and/or the like), annotating the data (e.g., using open vocabulary model(s) and/or other trained models capable of automatically identifying target content in the data), verifying correctness of the data (e.g., checking the format(s) of the data and/or data annotations), and/or the like.

In some embodiments, WFE 106 may schedule one task per container instantiated by MLM container services 108, e.g., MLM training or deployment. In other instances, a container may include an entire pipeline of tasks, starting from pre-processing and annotating training data 244, using one or more MLM backends 110 to fine-tune a number of user-selected pre-trained MLMs 242, optimize the fine-tuned MLMs for execution on client device 160, evaluate the optimized MLMs, re-train the optimized MLMs (if indicated by evaluation results), and storing the MLMs on cloud store 240 (client device 160 or some other user's space).

Scalable ML operations 200 may further include uploading intermediate results of MLM training to ML operations (MLOps) server 260 for visualization of the training process. In some embodiments, MLOps server 260 may be part of MLI cloud server 102. In other embodiments, MLOps server 260 may be an external (e.g., third-party) server (e.g., “Weights & Biases” MLOps, “ClearML” MLOps, and/or the like). MLOps server 260 may provide to user 202 various visual illustrations of the training process, e.g., histograms and dynamics of MLM parameters for different training epochs, plots (tables, charts, or any other suitable representations) of model's precision, accuracy, recall, values of a loss function, and/or the like. Based on the provided visualizations and/or other feedback, user 202 may modify the training process by, e.g., changing hyperparameters, starting or stopping experiments/tracks, changing or adding new training data, and/or performing any other suitable management operations.

FIG. 3 illustrates schematically an example container-based execution 300 of scalable ML operations on a cloud-based server, according to at least one embodiment. Container-based execution 300 may include instantiating an ML operations container 310, which may be a Kubernetes container, a DOCKER container, and/or the like. A set of requests from a user, received via client API, may include any number of tasks, e.g., MLM training tasks, MLM deployment tasks, training data annotation or augmentation tasks, and so on. Any given task may be scheduled (e.g., by WFE 106 of FIG. 2) as one or more jobs. Jobs and/or tasks may be grouped (by the WFE) into logical groups, individual groups executed in separate ML operations containers 310. In some instances, tasks associated with different MLMs may be executed in different containers while tasks related to the same MLM (e.g., fine-tuning, evaluation, and deployment of the same MLM) may be grouped into a single container. In some instances, an advanced user may select how different tasks are to be distributed among the containers. In other instances, e.g., when a user has no preferences (or lacks sufficient experience to make an informed selection), the WFE may automatically determine the optimal number of containers and distribute tasks among the containers, e.g., to maximize computational efficiency, speed of processing, reduce latency, and/or the like. For example, tasks that have to be processed sequentially may be grouped into a single container while unrelated tasks that can be processed in parallel may be distributed among multiple containers.

Requests from client API 164 may form a requests queue 320 that is received by a cloud API endpoint 330. Cloud API endpoint 330 may communicate with the WFE (not shown in FIG. 3) that allocates tasks to the ML operations container 310. Execution of the tasks assigned to the container may be orchestrated by a task execution engine 340. The user may provide names and/or addresses for one or more models, e.g., pre-trained models 370 stored on any suitable cloud store 240. The user may further provide hyperparameters 372, e.g., a JSON file, which may be located on cloud store 240 or, in some embodiments, directly selected and uploaded via client API 164. The user may further specify one or more addresses of a training dataset 374 to be used for training or fine-tuning of one or more pre-trained MLMs 370. Training dataset 374 may be a set provided by the MLI cloud server or a set of user's own data. A data controller 350 may fetch any, some, or all of the pre-trained MLM(s) 370, hyperparameters 372, and/or training dataset 374 from cloud store 240. Task execution engine 340 may initialize one or more tasks 360 on a selected configuration of one or more resources (indicated with shaded squares), e.g., processors and memory devices, of the compute platform resources 120 accessible to the MLI cloud server.

Some of the tasks 360 may train a previously untrained MLM model, e.g., using training dataset 374 provided by the user or dataset(s) provided by the MLI cloud server. Some of the tasks 360 may train (or fine-tune) one or more pretrained (e.g., by the MLI cloud server) MLMs 370 with training dataset 374 provided by the user. For example, an MLM may be pre-trained using a basic set of images as a general-purpose object recognition model. Using a TRAIN command provided by the client API 164, the user may specify training dataset 374 and/or one or more hyperparameters 372 to further train the MLM as a domain-specific model, e.g., as a medical image object recognition model. Hyperparameters 372 may be specific to a particular MLM architecture and/or type, e.g., object recognition models, speech recognition models, speech synthesis models, conversational models, etc., may have different default hyperparameters.

In some embodiments, responsive to a user's request, multiple MLMs may be trained based on a single pre-trained MLM 370 (or a new MLM) using different sets of training hyperparameters. After training is completed, one or more tasks 360 may include evaluating the trained MLMs by applying suitable evaluation metrics and identifying one or more preferred MLMs (e.g., MLM(s) with highest evaluation scores). In some embodiments, the evaluation metric may include accuracy of classifications obtained for an evaluation dataset (which may be a part of training dataset 374). The preferred MLMs may be identified to the user, e.g., as part of a training report 376 that includes evaluation scores. Training report 376 may be stored on cloud store 240 and/or provided to the user via client API 164. The user may then select some of the preferred MLMs to be stored as trained MLMs 378. Some of the tasks 360 may include deploying trained MLMs 378 for inference of new data. In some embodiments, the trained MLMs 378 may be deployed on the MLI cloud server (e.g., via one or more tasks 360). In some embodiments, the trained MLMs may be deployed for execution on computing devices that are different from the MLI cloud server.

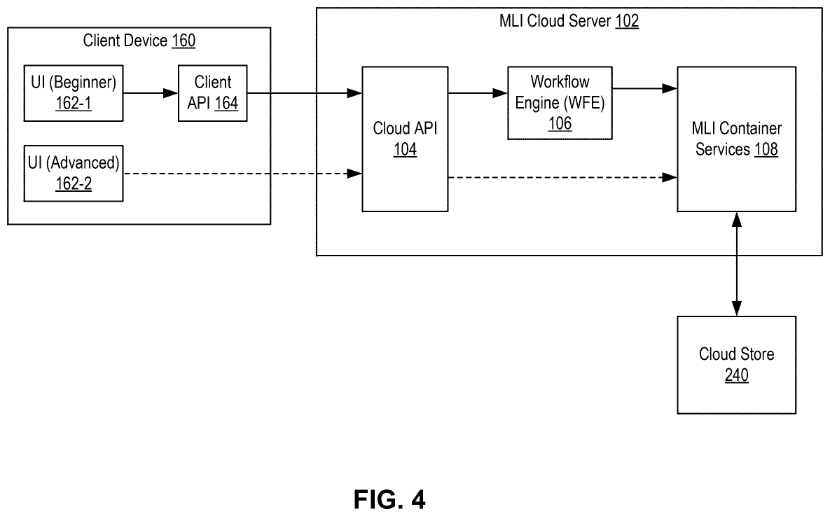

FIG. 4 illustrates schematically example modes of interaction between a user of a client device and a cloud server supporting ML operations, according to at least one embodiment. As illustrated, a beginner user may be provided with a UI 162-1, e.g., a browser-supported interface, which may support a set of high-level commands of client API 164 to the user. As indicated by the solid arrows, client API 164 may forward one or more requests of the user, entered using the high-level commands, to cloud API 104 that identifies tasks to be implemented on MLI container services 108. The WFE 106 may then schedule specific jobs to implement the identified tasks. As indicated by the dashed arrows, an advanced user may be provided with a UI 162-2 capable of receiving low-level commands from the user. The low-level commands may be provided to cloud API 104 that directly schedules tasks and jobs for execution on MLI container services 108, as selected by the advanced user.

In one example embodiment, cloud API 104 may support at least the following ML operations:
GET /api/v1/neural_networks (to list neural networks supported by the MI cloud server)
GET /api/v1/neural_networks {neural_network_name}/actions (to list supported actions for a given neural network)
POST /api/v1/neural_networks {neural_network_name}/actions/{action_name} (to run an action/task)
GET /api/v1/neural_networks {neural_network_name}/actions/{action_name}/{job_id} (to obtain a job status)
GET /api/v1/neural_networks {neural_network_name}/actions/{action_name}:ids (to list jobs for a given action)
GET /api/v1/neural_networks {neural_network_name}/actions/{action_name}:schema (to obtain an action specification schema)
PUT /api/v1/neural_networks {neural_network_name}/pretrained models (to list supported pretrained models for a given neural network)

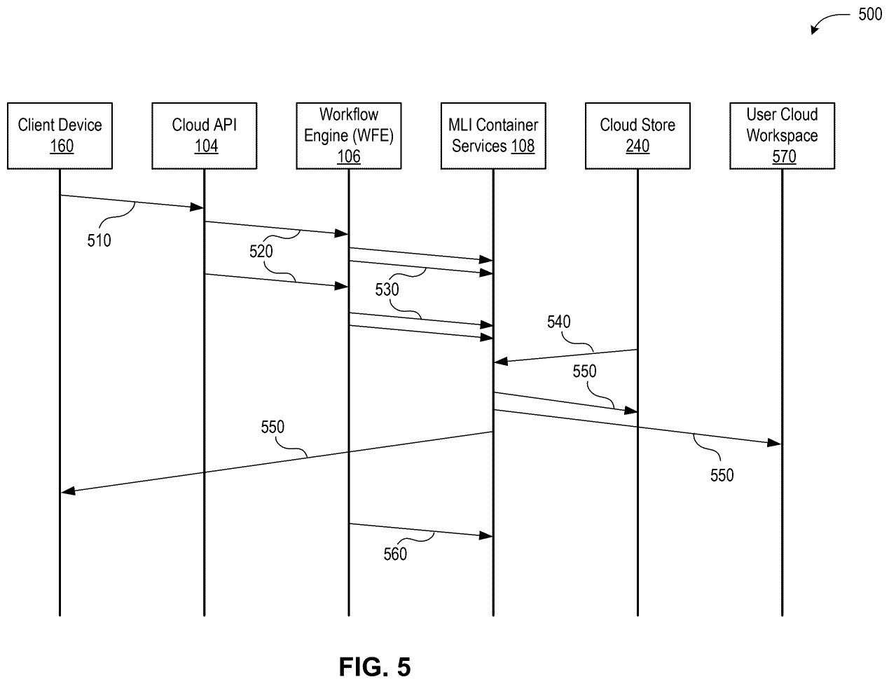

FIG. 5 illustrates schematically a flow of events 500 during scalable cloud execution of ML tasks, according to at least one embodiment. In one embodiment, as illustrated in FIG. 5, a client device 160 (via the client API) may receive one or more user's requests 510 for MLM tasks to be executed by the cloud service. The request can be for any MLM-related services, e.g., annotating a training dataset, augmenting a training dataset with variations of the training data, training one or more MLMs, fine-tuning one or more MLMs, exporting one or more MLMs, deploying one or more MLMs, performing inference using one or more MLMs, and/or the like. The client device 160 may forward the requests 510 to the cloud API 104, which may parse the requests 510 into one or more individual tasks 520 that are communicated to the WFE 106. WFE 106 may create containers associated with the individual tasks, various tasks scheduled via one or more jobs 530, and may allocate (using a suitable API call) appropriate on-demand cloud computing resources for job/task execution on MLI container services 108. The MLI container services 108 may allocate the identified resources and instantiate the container(s). The container(s) may initiate target tasks, e.g., MLM training/evaluation/deployment/etc., training data annotation or augmentation, and/or the like, and may download associated data 540 (e.g., training dataset, pretrained MLMs, etc.) from any user-specified cloud storage 240. The user-requested tasks (actions) may be executed in the container(s) using one or more MLI backends specified by the user or (if no user preference is received) by the WFE 106 based on the type of the MLM, amount and/or format of the training data, and/or the like. During container execution, various intermediate results 550 related to the task execution may be periodically reported to the client device 160 (e.g., via the client API) and/or stored in the cloud store 240 and/or a user cloud workspace 570 via suitable API reporting calls. After completion of the task execution, reporting and storing the final results, and/or the like, the cloud computing resources may be deallocated, e.g., using an API call 560, and returned to the common pool of resources. The container may then be deleted to ensure privacy and security of sensitive user data.

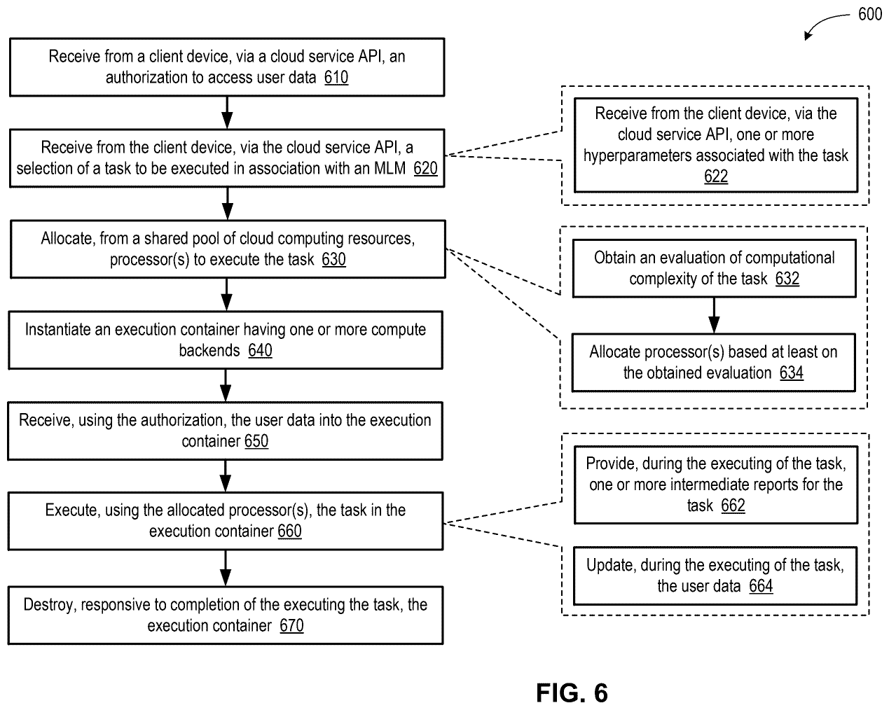

FIG. 6 is a flow diagram of an example method 600 of performing scalable ML operations using a cloud-based server, in accordance with at least some embodiments. FIG. 6 may be used to perform any suitable operations associated with one or more MLMs (e.g., training, adapting, optimizing, deploying MLMs) and/or modifying data associated with one or more MLMs (e.g., training data for one or more MLMs). Method 600 may be performed in conjunction with MLMs used in voice recognition, speech recognition, speech synthesis, object detection, object recognition, motion detection, hazard detection, robotics applications, forecasting, language models (including large language models), and any other contexts and applications where machine learning may be used. In at least one embodiment, method 600 may be performed by processing units (e.g., GPUs, CPUs, etc.) of MLI cloud server 102 (with reference to FIG. 1A or FIG. 2) or processing units of some other computing device, or a combination of multiple computing devices. The one or more processing units may include (or communicate with) one or more memory devices. In at least one embodiment, method 600 may be performed by multiple processing threads (e.g., CPU threads and/or GPU threads), individual threads executing one or more functions, routines, subroutines, or operations of the method. In at least one embodiment, processing threads implementing method 600 may be synchronized, e.g., using semaphores, critical sections, and/or other thread synchronization mechanisms. Alternatively, processing threads implementing method 600 may be executed asynchronously with respect to each other. Various operations of method 600 may be performed in a different order compared with the order shown in FIG. 6. Some operations of the methods may be performed concurrently with other operations. In at least one embodiment, one or more operations shown in FIG. 6 may not always be performed. Although for brevity and conciseness, the description below references a single MLM, operations of method 600 may similarly be performed in conjunction with multiple MLMs.

At block 610, processing units performing method 600 may receive from a client device (e.g., client device 160 in FIG. 2), via a cloud service API (e.g., cloud API 104), authorization data. In some embodiments, the authorization data to access the user data may include a storage address (e.g., a URL) of the user data. In some embodiments, the storage address references a cloud storage location of the user data. The storage location may be on a cloud storage that is different from the cloud service performing method 600. In some embodiments, the authorization data may further include a password to access the user data or a representation (e.g., a hash) of the password to access the user data.

At block 620, method 600 may continue with receiving from the client device, via the cloud service API, a selection of a task to be executed in association with a machine learning model (MLM). In some embodiments, the task includes training the MLM, optimizing the MLM, evaluating the MLM, deploying the MLM, performing, using the MLM, inference processing of the user data, and/or any combination thereof. In some embodiments, the task may include modifying the user data in association with the MLM, e.g., modifying (annotating, augmenting, etc.) a training dataset for the MLM. In some embodiments, method 600 may include, at block 622, receiving from the client device, via the cloud service API, one or more hyperparameters associated with the task (e.g., hyperparameters for training of the MLM).

At block 630, method 600 may continue with allocating, from a shared pool of cloud computing resources (e.g., compute platform resources 120 in FIG. 2), one or more processors to execute the task. The shared pool of cloud computing resources may be concurrently used for execution of a plurality of additional tasks received from one or more additional client devices. In some embodiments, the number of additional tasks may be large, e.g., such that a processing load associated with execution of the task is less than one tenth (one hundredth, one thousandth, etc.) of a combined processing load associated with execution of the plurality of additional tasks. In some embodiments, the one or more processors may include one or more GPUs. In some embodiments, the one or more processors may be identified by a user (e.g., user 202 in FIG. 2) of the client device.

In some embodiments, allocating the one or more processors to execute the task may include operations illustrated by the middle callout portion of FIG. 6. More specifically, at block 632, operations of method 600 may include obtaining, using a workflow engine associated with the cloud service API, an evaluation of computational complexity of the task. At block 634, method 600 may continue with allocating the one or more processors based at least on the obtained evaluation.

At block 640, method 600 may include instantiating an execution container (e.g., ML operations container 310 in FIG. 3) that includes one or more compute backends. The one or more compute backends may include one or more TensorFlow® backends, one or more PyTorch® backends, one or more TensorRT® backends, one or more a ONNX® backends, one or more Keras® backends, and/or any combination thereof.

At block 650, method 600 may continue with receiving, using the authorization data, the user data (e.g., one or more pre-trained MLMs 370, one or more hyperparameters 372, one or more training datasets 374, and/or the like) into the execution container.

At block 660, method 600 may include executing, using the one or more processors, the task in the execution container. In some embodiments, as illustrated by the bottom callout portion of FIG. 6, container execution may include, at block 662, providing, during the executing of the task, one or more intermediate reports associated with the executing of the task. At block 664, method 600 may include updating, during the executing of the task, the user data (e.g., uploading training report 376, one or more trained MLMs 378, the updated—annotated and/or augmented—training dataset 374, and/or the like).

In some embodiments, at block 670, the one or more processing units performing method 600 may destroy (e.g., removed, deleted, etc.), responsive to completion of the executing the task, the execution container.

### Inference and Training Logic

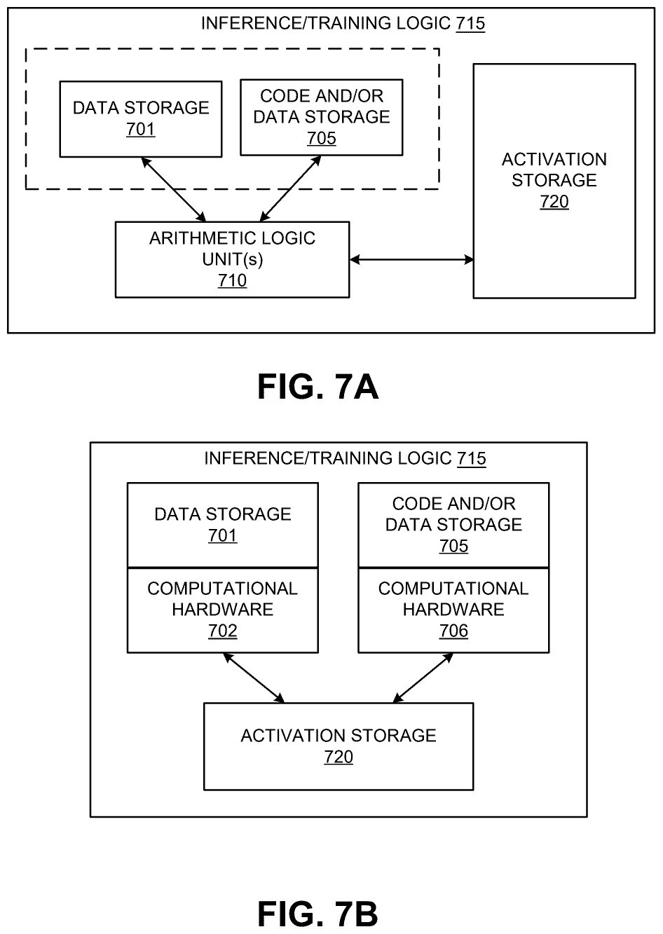

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

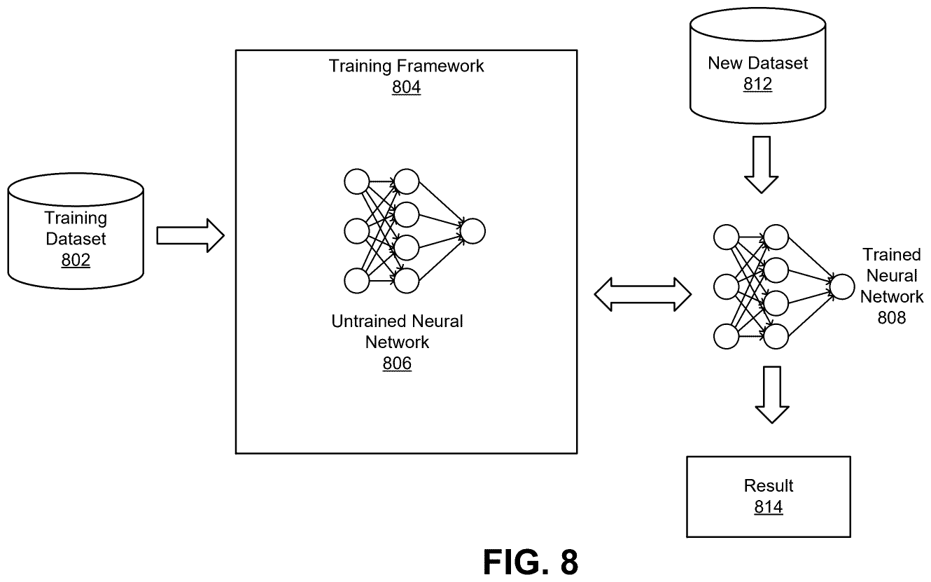

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

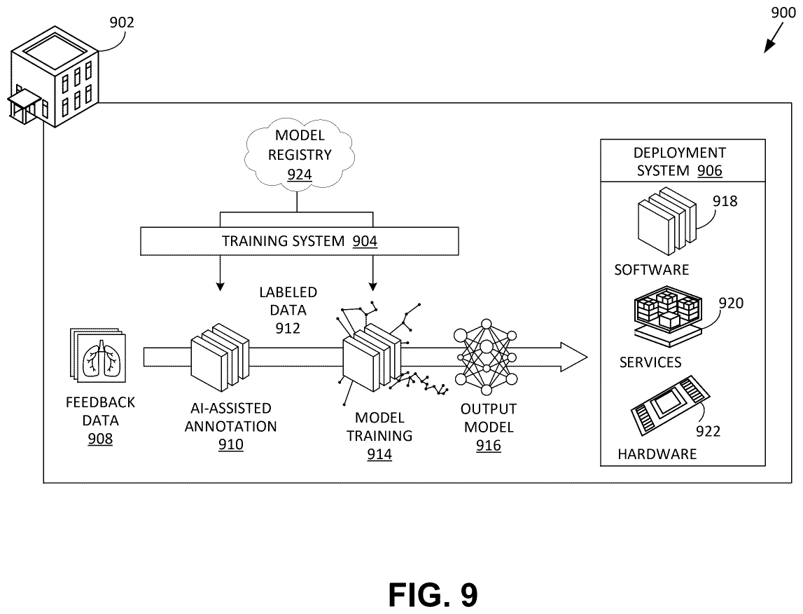

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

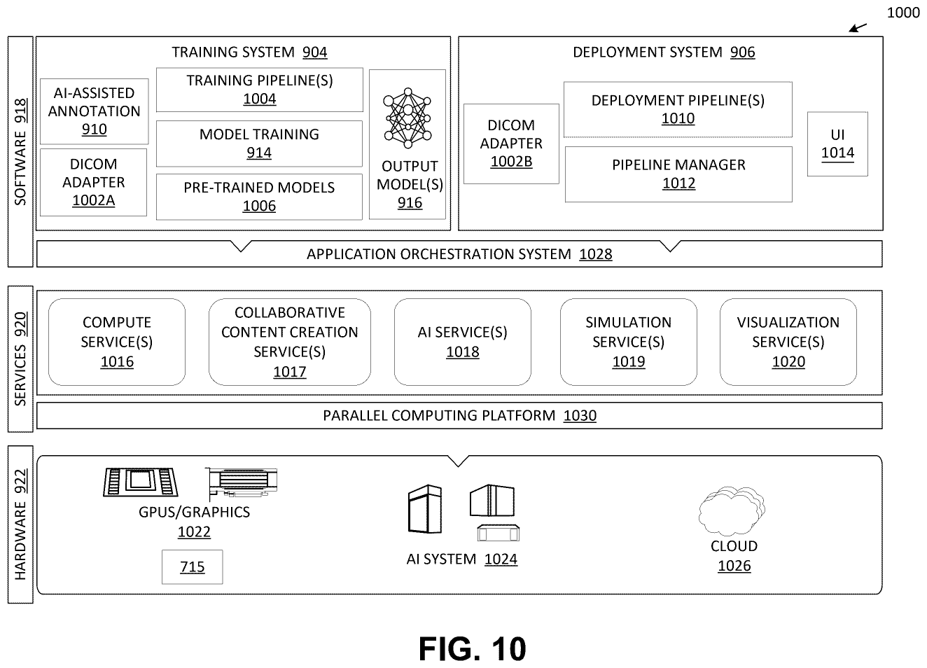

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Data Center

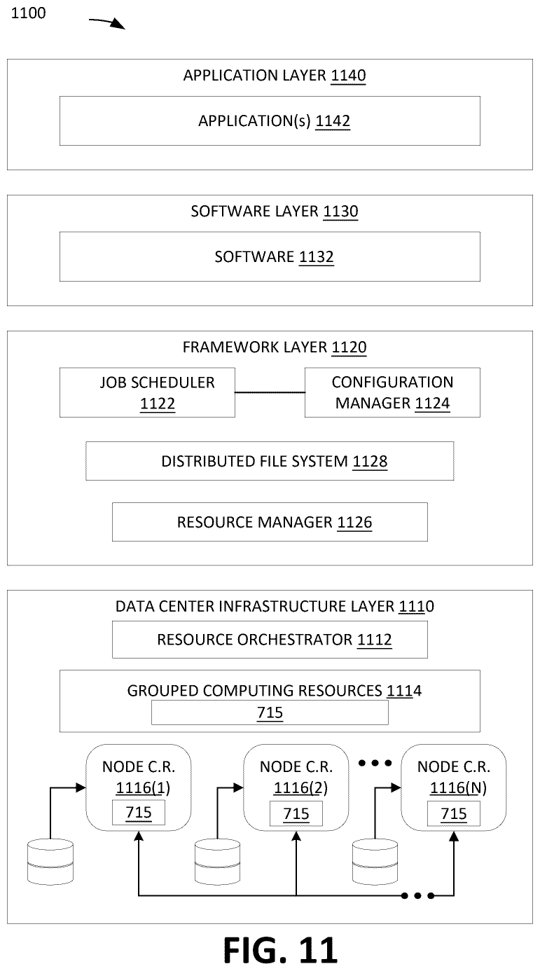

FIG. 11 illustrates an example data center 1100, in which at least one embodiment may be used. In at least one embodiment, data center 1100 includes a data center infrastructure layer 1110, a framework layer 1120, a software layer 1130, and an application layer 1140.

In at least one embodiment, as shown in FIG. 11, data center infrastructure layer 1110 may include a resource orchestrator 1112, grouped computing resources 1114, and node computing resources (“node C.R.s”) 1116(1)-1016(N), where “N” represents any whole, positive integer. In at least one embodiment, node C.R.s 1116(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1116(1)-1116(N) may be a server having one or more of above-mentioned computing resources.

In at least one embodiment, grouped computing resources 1114 may include separate groupings of node C.R.s housed within one or more racks (not shown), or many racks housed in data centers at various geographical locations (also not shown). Separate groupings of node C.R.s within grouped computing resources 1114 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1112 may configure or otherwise control one or more node C.R.s 1116(1)-1116(N) and/or grouped computing resources 1114. In at least one embodiment, resource orchestrator 1112 may include a software design infrastructure (“SDI”) management entity for data center 1100. In at least one embodiment, resource orchestrator may include hardware, software or some combination thereof.

In at least one embodiment, as shown in FIG. 11, framework layer 1120 includes a job scheduler 1122, a configuration manager 1124, a resource manager 1126 and a distributed file system 1128. In at least one embodiment, framework layer 1120 may include a framework to support software 1132 of software layer 1130 and/or one or more application(s) 1142 of application layer 1140. In at least one embodiment, software 1132 or application(s) 1142 may respectively include web-based service software or applications, such as those provided by Amazon Web Services, Google Cloud and Microsoft Azure. In at least one embodiment, framework layer 1120 may be, but is not limited to, a type of free and open-source software web application framework such as Apache Spark™ (hereinafter “Spark”) that may utilize distributed file system 1128 for large-scale data processing (e.g., “big data”). In at least one embodiment, job scheduler 1122 may include a Spark driver to facilitate scheduling of workloads supported by various layers of data center 1100. In at least one embodiment, configuration manager 1124 may be capable of configuring different layers such as software layer 1130 and framework layer 1120 including Spark and distributed file system 1128 for supporting large-scale data processing. In at least one embodiment, resource manager 1126 may be capable of managing clustered or grouped computing resources mapped to or allocated for support of distributed file system 1128 and job scheduler 1122. In at least one embodiment, clustered or grouped computing resources may include grouped computing resource 1114 at data center infrastructure layer 1110. In at least one embodiment, resource manager 1126 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1128 of framework layer 1120. The one or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1128 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1124, resource manager 1126, and resource orchestrator 1112 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underutilized and/or poor performing portions of a data center.

In at least one embodiment, data center 1100 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1100. In at least one embodiment, trained machine learning models corresponding to one or more neural networks may be used to infer or predict information using resources described above with respect to data center 1100 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 8A and/or 8B. In at least one embodiment, inference and/or training logic 715 may be used in system FIG. 11 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some embodiments, process of obtaining, acquiring, receiving, or inputting analog or digital data may be accomplished by transferring data via a serial or parallel interface. In another embodiment, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example embodiments of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
receiving from a client device, via a cloud service API, a selection of a task to be executed in association with a machine learning model (MLM);
allocating, from a shared pool of cloud computing resources, one or more processors to execute the task, wherein the shared pool of cloud computing resources is being concurrently used for execution of a plurality of additional tasks received from one or more additional client devices;
instantiating an execution container comprising one or more compute backends;
receiving, using authorization data, the user data into the execution container; and
executing, using the one or more processors, the task in the execution container.

2. The method of claim 1, wherein the authorization data comprises:
a storage address of the user data, and
at least one of:
a password to access the user data, or
a representation of the password to access the user data.

3. The method of claim 2, wherein the storage address references a cloud storage location of the user data.

4. The method of claim 1, wherein the task comprises at least one of:
training the MLM,
optimizing the MLM,
evaluating the MLM,
deploying the MLM,
performing, using the MLM, inference processing of the user data, or
modifying the user data in association with the MLM.

5. The method of claim 1, wherein the one or more processors comprise one or more graphics processing units (GPUs).

6. The method of claim 1, wherein a processing load associated with execution of the task is less than one tenth of a combined processing load associated with execution of the plurality of additional tasks.

7. The method of claim 1, wherein the one or more processors are identified by a user of the client device.

8. The method of claim 1, wherein allocating the one or more processors to execute the task comprises:
obtaining, using a workflow engine associated with the cloud service API, an evaluation of computational complexity of the task; and
allocating the one or more processors based at least on the obtained evaluation.

9. The method of claim 1, wherein the one or more compute backends comprise at least one of:
a TensorFlow backend,
a PyTorch backend,
a TensorRT backend,
a ONNX backend, or
a Keras backend.

10. The method of claim 1, further comprising:
providing, during the executing of the task, one or more intermediate reports associated with the executing of the task.

11. The method of claim 10, further comprising:
updating, during the executing of the task, the user data.

12. The method of claim 1, further comprising:
destroying, responsive to completion of the executing the task, the execution container.

13. The method of claim 1, further comprising:
receiving from the client device, via the cloud service API, one or more hyperparameters associated with the task.

14. A system comprising:
one or more processing units to:
receive from a client device, via a cloud service API, a selection of a task to be executed in association with a machine learning model (MLM);
allocate, from a shared pool of cloud computing resources, one or more processors to execute the task, wherein the shared pool of cloud computing resources is being concurrently used for execution of a plurality of additional tasks received from one or more additional client devices;
instantiate an execution container comprising one or more compute backends;
receive, using authorization data, the user data into the execution container; and
execute, using the one or more processors, the task in the execution container.

15. The system of claim 14, wherein the authorization data comprises:
a storage address of the user data, and
at least one of:
a password to access the user data, or
a representation of the password to access the user data.

16. The system of claim 14, wherein a processing load associated with execution of the task is less than one tenth of a combined processing load associated with execution of the plurality of additional tasks.

17. The system of claim 14, wherein to allocate the one or more processors to execute the task, the one or more processing units are to:
obtain, using a workflow engine associated with the cloud service API, an evaluation of computational complexity of the task; and
allocate the one or more processors based at least on the obtained evaluation.

18. The system of claim 14, wherein the one or more processing units are further to:
provide during the executing of the task, one or more intermediate reports associated with the executing of the task; and
update, during the executing of the task, the user data.

19. The system of claim 14, wherein the system is comprised in at least one of:
an in-vehicle infotainment system for an autonomous or semi-autonomous machine;
a system for performing one or more simulation operations;
a system for performing one or more digital twin operations;
a system for performing one or more medical operations;
a system for performing one or more factory operations;
a system for performing one or more analytics operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more vision language models (VLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. A non-transitory computer-readable memory storing instructions thereon that, when executed by a processing device, cause performance operations comprising:
receiving from a client device, via a cloud service API, a selection of a task to be executed in association with a machine learning model (MLM);
allocating, from a shared pool of cloud computing resources, one or more processors to execute the task, wherein the shared pool of cloud computing resources is being concurrently used for execution of a plurality of additional tasks received from one or more additional client devices;
instantiating an execution container comprising one or more compute backends;
receiving, using authorization data, the user data into the execution container; and
executing, using the one or more processors, the task in the execution container.
